(19) United States
(12) Patent Application Publication
(10) Pub. No.: US 2007/0021783 A1
(43) Pub. Date: Jan. 25, 2007

(54) Vaporizer pacifier

(76) Inventors: Aida Viana, Miami, FL (US); Lidia Viana, Miami, FL (US)

Correspondence Address: William R. Trueba, Jr;Kluger, Peretz, Kaplan & Berlin, P.L., Miami Center - 17th Floor, 201 South Biscayne Boulevard, Miami, FL, 33131, US

(21) Appl. No.: 11/490,430

(22) Filed: Jul. 20, 2006

Related U.S. Application Data
(60) Provisional application No. 60/700,981, filed on Jul. 20, 2005.

(51) Int. Cl. A61J 17/00

(52) U.S. Cl. 606/234

(57) ABSTRACT

A vaporizer pacifier is provided comprising a base member having an outwardly projecting stop member, a nipple having a proximal end coupled to the base member, and a substantially cylindrical compartment attached to a proximal end of the base member. The compartment comprises two substantially co-centric, cylindrical members. A first is attached to the base member and defines an opening adapted and sized to allow a medicinal disc to pass through into the compartment and also defines at least one aperture to allow the medicinal vapors to escape. The second is rotatably coupled to the first, has a closed end and defines a first opening sized similar to the opening of the first member. The two members can be rotated such windows on each substantially align in one position and causes the one or more apertures to be exposed through the first opening in a second position.

### CROSS-REFERENCE TO RELATED APPLICATIONS

The present application claims priority to U.S. provisional patent application No. 60/700,981 filed Jul. 20, 2005. The entire disclosure of U.S. provisional patent application No. 60/700,981 is incorporated herein by reference.

### FIELD OF THE INVENTION

The present invention relates to a vaporizer pacifier, and more specifically, to a pacifier having a rotating compartment structured to hold a disk impregnated with a vapor releasing agent for decongestion or for soothing an infant or small child.

### BACKGROUND OF THE INVENTION

Pacifiers have been in existence for hundreds, if not thousands, of years. For at least as long, caretakers have sought solutions for the respiratory ailments of infants. In the past, caretakers placed a vapor releasing balm or paste on the infant's skin or used electric steam producing devices or humidifiers with liquid medicine chambers to maximize the efficacy of the treatment. More recently, devices for administering such treatment via an infant's pacifier have become known. Such devices have their limitations, particularly with respect to the containment of the vapor-producing medicinal agent. Inadequate containment of the vapor-producing medicinal agent can pose a safety risk to the infant because it can lead to exposure of the infant to the agent in forms and doses which are unintended and unsafe. In addition, inadequate containment of the vapor-producing agent can cause an inconvenient mess for the caretaker. For example, the vaporizing pacifiers disclosed in UK patents 2,231,497 and 2,269,754 to Singh disclose vaporizing pacifiers that employ compartments to contain the medicinal agents. However, these prior art vaporizing pacifiers would require the caretaker to add the messy medicine directly into the compartments, and would make removal of the residue of old medicine inside the pacifier difficult. This mess would result in a hazard to the infant and inconvenience to the caretaker. Furthermore, these prior art pacifiers do not provide for a means to prevent the infant from opening the medicine containing compartments. Should an infant open such a compartment, the infant could be in danger from the released medicine, and even in the best case scenario, a mess would be inevitable. U.S. Pat. No. 5,868,131 to Murchie discloses a pacifier that employs replaceable vapor-dispensing modules. However, these medicines still exist in a potentially dangerous and messy form inside those modules. Furthermore, the modules do not have specialized means for preventing the infant from tampering with the module and its contents. The present invention solves these problems by providing a vaporizing pacifier that employs a tamper-resistant lock pin to prevent the infant from accessing or releasing the vaporizing medicinal agent in use. In addition, the present invention solves the problems of prior art vaporizing pacifiers by employing medicinal disks impregnated with an agent that produces vapors. The disks are clean, easily replaceable with minimal mess, and difficult for an infant to remove from the pacifier. The disks provide the additional benefit of substantially retaining the medicinal agent in the event that the pacifier is opened or the disk removed. In sum, the present invention provides a means of providing vaporizing medicine to an infant that is soothing and safe for the infant, and clean and easy to use for the caretaker.

### OBJECTS OF THE INVENTION

The following section of the written description describes some of the objects of the present invention, but the section is not exhaustive of all of invention's objects.

It is an object of the present invention to provide a vaporizing pacifier, and more particularly, one that is safe for infants.

It is a further object of the present invention to provide a vaporizing pacifier that includes a lock pin that enhances the safety of the pacifier in as much as the lock pin prevents the release of potentially toxic medicine where they can be ingested by an infant.

It is yet another object of the present invention to provide a vaporizing pacifier that includes a lock pin that prevents mess in as much as it prevents the inadvertent release of the vaporizing medicines.

It is yet another object of the present invention to provide a pacifier that employs medicinal disks impregnated with an agent that produces vapors that enhance the safety of the pacifier in as much as the use of an impregnated disk prevents the inadvertent release of the vaporizing medicines.

It is yet another object of the present invention to provide a pacifier that employs medicinal disks impregnated with an agent that produces vapors that prevent mess in as much as the use of an impregnated disk prevents the inadvertent release of the vaporizing medicines.

It is yet another object of the present invention to provide a pacifier that employs medicinal disks impregnated with an agent that produces vapors that prevent mess in as much as the disks are easy to replace and do not require that the residue of old medicine be removed from the pacifier.

### SUMMARY OF THE INVENTION

The present invention provides a vaporizer pacifier for an infant comprising a base member having an outwardly projecting stop member, the stop member adapted to prevent the pacifier from becoming a choking hazard to the infant. The vaporizer pacifier includes a nipple having a proximal end coupled to a distal side of the base member and a distal end protruding substantially perpendicular to the outwardly projecting stop member. The pacifier includes a substantially cylindrical compartment attached to a proximal end of the base member, the compartment comprising a first substantially cylindrical member attached to the base member, the first member defining an opening adapted and sized to allow a medicinal disc to pass through into the compartment. The first member defines at least one aperture having dimensions smaller than the medicinal disc for the purpose of allowing the vapor in the compartment to escape. The first member also defines a biased lock pin. The cylindrical compartment also includes a second substantially cylindrical member having a closed end and sized to fit about the first substantially cylindrical member. The second member is rotatably coupled to the first member and defines a first opening sized similar to the opening of the first cylindrical member and positioned such that rotation of the second member about the first member causes the first opening to substantially align with the opening of the first member in one position and causes the at least one aperture of the first member to be exposed through the first opening of the second member in a second position. The second member also defines a second opening shaped to allow at least a portion of the lock pin of the first member to protrude through the second member in the second position. This locks the compartment and prevents a child or infant from opening the compartment such that the medicinal disk is able to slip out.

In one embodiment, the apertures on the substantially cylindrical compartment are positioned on a portion of the first substantially cylindrical member in close proximity to a portion of the base member adapted to be near the infant's nasal passages. This ensures that the soothing vapors waft near the infant's face during use of the pacifier. The medicinal disk of the present invention is sized to fit within the compartment and impregnated with an agent that produces vapors. Agents may include menthol, eucalyptus, rosemary, lavender and the like.

Another embodiment of the vaporizer pacifier of the present invention may also comprise a base member having an outwardly projecting stop member, the stop member adapted to prevent the pacifier from becoming a choking hazard to the infant; a nipple having a proximal end coupled to a distal side of the base member and a distal end protruding substantially perpendicular to the outwardly projecting stop member; and a substantially cylindrical compartment attached to a proximal end of the base member wherein the substantially cylindrical members of the compartment are reversed. That is, the inner member rotates relative to the stationary outer member. In accordance with this embodiment, the compartment comprises a first substantially cylindrical member attached to the base member, the first member defining a first opening adapted and sized to allow a medicinal disc to pass through into the compartment, the first member defining a second opening; and a second substantially cylindrical member having a closed end and sized to fit within the first substantially cylindrical member. The second member is rotatably coupled to the first member and defines an opening sized similar to the first opening of the first cylindrical member. The second member also defines a biased lock pin. The opening of the second member is positioned such that rotation of the second member within the first member causes the opening of the second member to substantially align with the first opening of the first member in one position, and only a portion of the opening of the second member is exposed through the first opening of the first member and a portion of the lock pin protrudes into the second opening of the first member in a second position.

### BRIEF DESCRIPTION OF THE DRAWINGS

The subject matter which is regarded as the invention is particularly pointed out and distinctly claimed in the claims at the conclusion of the specification. The foregoing, and other objects, features, and advantages of the present invention are shown and described in the following detailed description of the preferred embodiments which should be viewed in conjunction with the accompanying drawings in which:

FIG. 1 illustrates one embodiment of the vaporizer pacifier of the present invention;

FIG. 2 illustrates how a medicinal disk is inserted into one embodiment of the vaporizer pacifier;

FIG. 3 illustrates a perspective view of one embodiment of the present invention;

FIG. 4 diagrammatically illustrates one embodiment of the vaporizer clip of the present invention with the attachment means in the open position;

FIG. 5 diagrammatically illustrates another embodiment of the vaporizer clip;

FIG. 6 illustrates one embodiment of the vaporizer pacifier of the present invention;

FIG. 7 is an exploded view of the components of the embodiment of the present invention illustrated in FIG. 6;

FIG. 8 is a cut-away view of the embodiment of FIG. 6 from the perspective of line 200′-200″;

FIG. 9 is an exploded view of the components of an alternative embodiment of the vaporizer pacifier of the present invention; and

FIG. 10 is a cut-away view of the embodiment of FIG. 9 from the perspective of line 300′-300″.

### DETAILED DESCRIPTION OF THE PREFERRED EMBODIMENTS

The present invention relates to a vapor releasing pacifier and clip-on container that can be used to provide congestion relief medicine or similar substances through (i) a pacifier; and (ii) a clip-on container; and more specifically, a pacifier and clip-on container having a chamber inaccessible to an infant or child designed to hold either medicine or a medicine retaining disk. The term medicine as used herein is intended to encompass natural oils and agents such as menthol, eucalyptus, rosemary, lavender and the like. One of the intended purposes of the pacifier and clip-on container of the present invention is to ease congestion and coughing in infants and small children. Although the vaporizer clip may be used by persons of all ages, the embodiments of both the vapor clip and pacifier described herein are designed with additional safety features that make them suitable for use with infants and children. In one embodiment, the pacifier includes a chamber defining a slit through which a disk containing a medically approved decongestant may be inserted. The present invention also relates to a vapor releasing pin or container that can be used to provide congestion relief medicine or aromatherapy. Again, the clipped-on container or pin includes a chamber inaccessible to the infant or child designed to hold medicine, a medicine disk or aromatherapy oil or disk. In one embodiment, the pin includes a chamber defining a slit through which a disk containing the medically approved decongestant or aromatherapy may be inserted. The pin is attached to the child's clothing in close proximity to the infant's nasal passages thereby significantly increasing the infant's exposure to the vapors. The container embodiment includes a clip which is used to affix the container to the infant's clothing. In the preferred embodiment, the clip on the container is child proof such that only an older child or adult is able to remove it. In the pacifier embodiment, as the infant suckles on the pacifier, vapors escape the chamber located away from the pacifier nipple and in close proximity to the infant's nasal passages thereby significantly increasing the infant's exposure to the medicinal vapors. Similarly, the clip, located in close proximity to the child's face, allows vapors to be breathed in by the infant or child. In both embodiments, the medicine chamber includes specially designed ventilation holes through which the vapors escape.

It is important to note that the embodiments of the invention described below are only examples of some of the uses of the teachings described herein. In general, statements made in the specification do not limit any of the various claimed inventions. Moreover, some statements may apply to some inventive features but not to others. Unless otherwise indicated, singular elements may be in the plural and vice versa with no loss of generality. Similar reference numerals and letters represent similar components and features throughout the drawings and the written description.

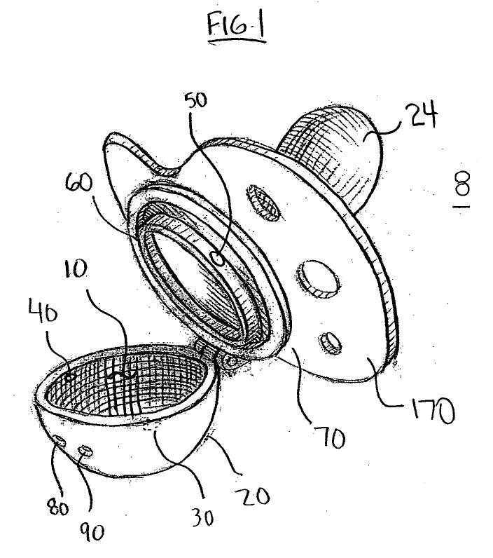

FIG. 1 diagrammatically illustrates a pacifier 8 having a compartment or chamber 10 defined by a hinged cover 20. Cover 20 includes two detents 30, 40 which cooperate with the protrusions 50 and 60 (60 is hidden from view) to lock the cover 20 onto the proximal end of the pacifier base member 70 (using the nipple tip as the distal reference point). Ventilation holes 80 and 90 provide a passage or aperture through which vapors emanating from the medicine stored in chamber 10 may escape for inhalation by the infant or child.

FIG. 2 diagrammatically illustrates another embodiment of the present invention which includes a slotted chamber 10. Slot 12 is of sufficient size to permit the insertion of a tablet or disk 14 or other medicine filled medium such as a liquid-retaining material. The opening 12 would allow the disk 14 to be securely inserted in the chamber 10 behind the mouth guard or stop shield 70.

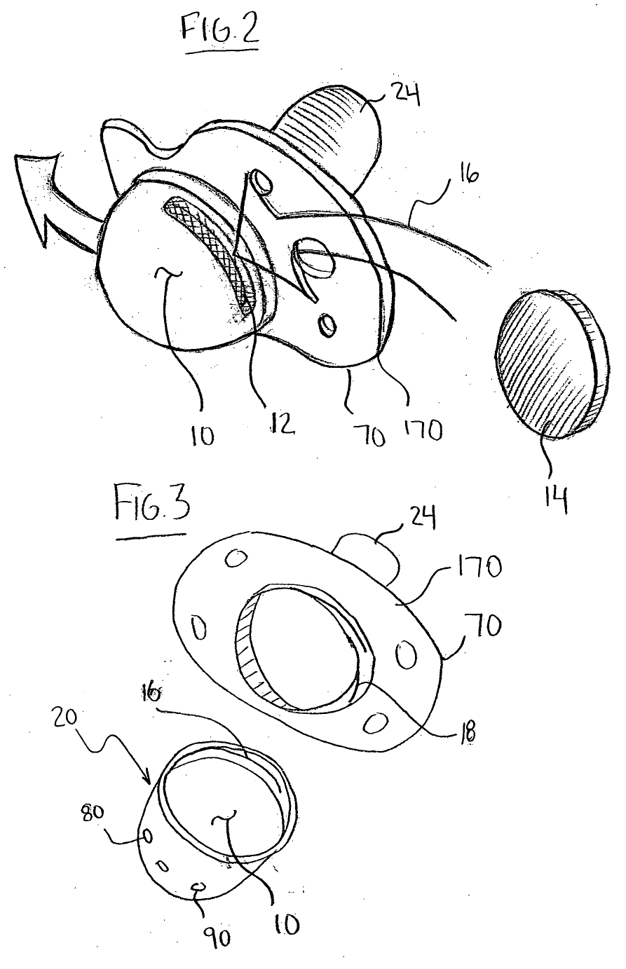

FIG. 3 illustrates another embodiment of the vaporizer pacifier of the present invention in which compartment 20 is detachably coupled to the base member 70 by means of cooperating threaded members 16, 18. Of course, other coupling means may be used. This embodiment prevents the medicinal disk 14 or other medicinal carrying means from coming in direct contact with the infant or small child.

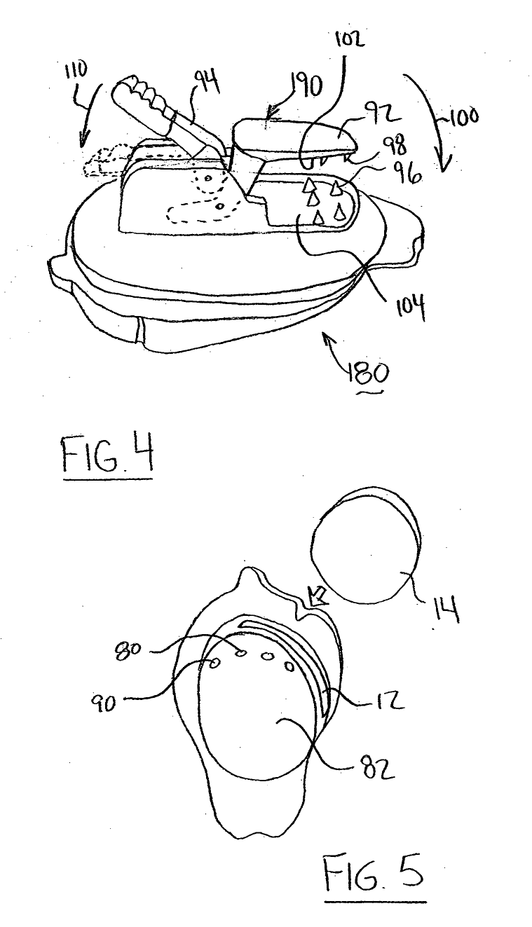

FIG. 4 diagrammatically illustrates an embodiment of the vapor releasing container 180 having a clip 190 used to attach the container 180 to the clothing worn by an infant or small child. In one embodiment of the clip-on container 180, a small container 82 defines a chamber having a slit through which a disk 14 or similar insert containing a medically approved decongestant may be inserted. The container portion 82 (FIG. 5) is similar to chamber or compartment 10 of the pacifier illustrated in FIGS. 1-3. Similarly, the chamber or container portion 82 may include a slot 12 or be constructed with a removable cap as illustrated in FIGS. 1 and 3. The clip portion may be embodied in a device having two levers 92, 94. An outer surface 104 of the back side of container 180 includes outwardly projecting teeth 96. Lever 92 includes inwardly projecting teeth 98. Lever 92 is designed to be moved in the direction of arrow 100 to capture the infant's clothing between the inner surface 102 and outer surface 104. The teeth 96, 98 on the respective surfaces 104, 102 are designed to prevent the clip from being pulled free of the clothing once the clip is secured. Lever 94 is a locking lever designed to hold lever 92 in place once put in a downward position as shown (see arrow 110).

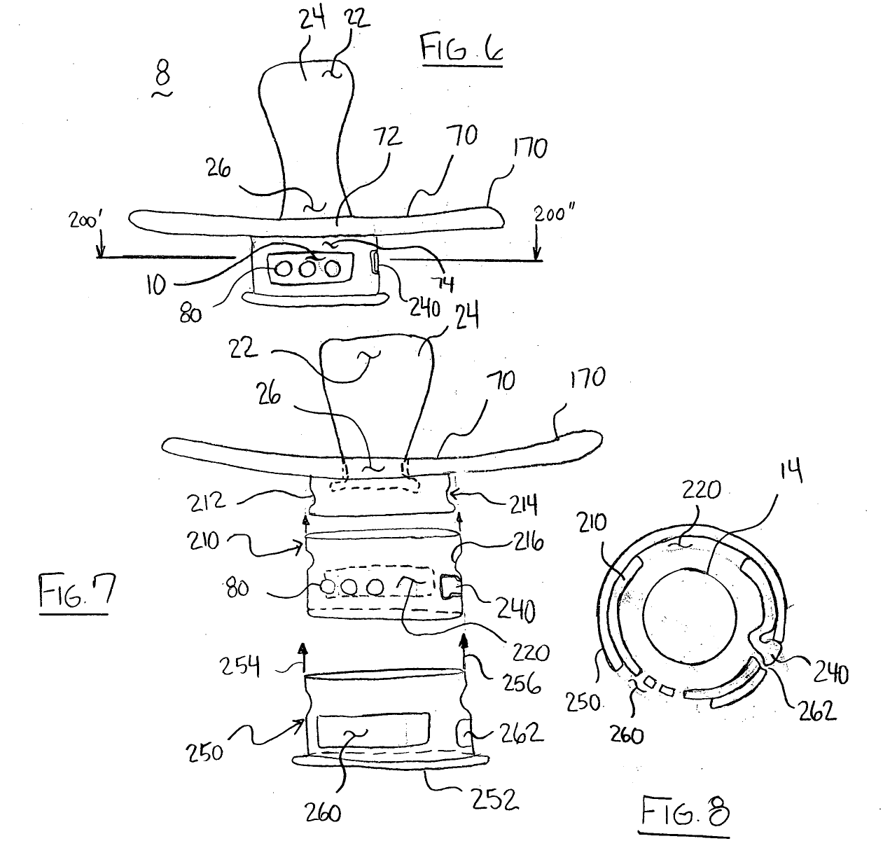

FIG. 6 illustrates another embodiment of the vaporizer pacifier 8 of the present invention. The vaporizer pacifier 8 includes a base member 70 having an outwardly projecting stop member 170. The stop member 170 is adapted to prevent the pacifier 8 from becoming a choking hazard to an infant or child. The pacifier 8 also includes a nipple 24 having a proximal end 26 coupled to a distal side 72 of the base member 70 and a distal end 22 protruding substantially perpendicular to the outwardly projecting stop member 170. The pacifier also includes a substantially cylindrically shaped compartment 10 attached to a proximal end 74 of the base member 70. In one embodiment, the compartment 10 includes a first substantially cylindrical member 210 attached to the base member 70. In the embodiment illustrated in FIG. 6, the first member 210 is snap-fit onto base member 70 by means of the protruding ring 212. Ring 212 includes a radially smaller area 214 over which the channel 216 of the first member 210 snaps. Alternatively, first member 210 may be molded together with base member 70 during the manufacturing of the part. The various components of the present inventions are typically made of silicone, rubber and plastic, but other materials may also be used. For example, the biased lock pin 240 made be constructed of a metallic material. First member 210 defines a first opening 220 (see also FIGS. 7 and 8). The first opening 220 is adapted and sized to allow a medicinal disc 14 to pass through into the compartment 10. The first member 210 also defines at least one aperture 80 having dimensions smaller than the medicinal disc 14. In the embodiment illustrated in FIGS. 6 through 8, three apertures are shown.

First member 210 also includes a biased lock pin 240. In the embodiment illustrated in FIGS. 6 through 8, biased lock pin 240 is constructed by molding it integrally with first member 210. However, other means may be implemented to create a biased lock pin as is known to those skilled in the art. For example, a push pin biased by a metallic strip may included within chamber 10. In the preferred embodiment, lock pin 240 protrudes radially outward of first member 210.

The embodiment illustrated in FIGS. 6 through 8 includes a second substantially cylindrical member 250 having a closed end 252 and sized to fit about the first substantially cylindrical member 210. Arrows 254, 256 indicate that second member 250 slides over first member 210 in FIG. 7. The second member 250 is rotatably coupled to the first member 210 and defines a first opening 260 sized similar to the opening 220 of the first cylindrical member 210. The first opening 260 of second member 250 is positioned such that rotation of the second member 250 about the first member 210 causes the first opening 260 to substantially align with the opening 220 of the first member 210 in one position, and causes the apertures 80 to be exposed through the first opening 260 in a second position (as shown in FIG. 6).

The vaporizer pacifier embodiment 8 illustrated in FIGS. 6 through 8 include a second opening 262 defined by the second member 250. The second opening 262 is shaped to allow at least a portion of the lock pin 240 to protrude through the second member 250 in the aforementioned second position.

In operation, lock pin 240 must be pressed into chamber or compartment 10 in order to rotate the outer second member 250 relative to inner first member 210. Once the openings or windows 220 and 260 align, the user is able to slide disk 14 into the compartment 10. Once placed in, outer member cylindrical member 250 is rotated until the bias lock pin 240 snaps into opening 262, thus locking the outer member relative to the inner member. This locking mechanism makes the present invention safer than the prior pacifier because infant and small children are unable to access the medicinal materials inside the chamber 10.

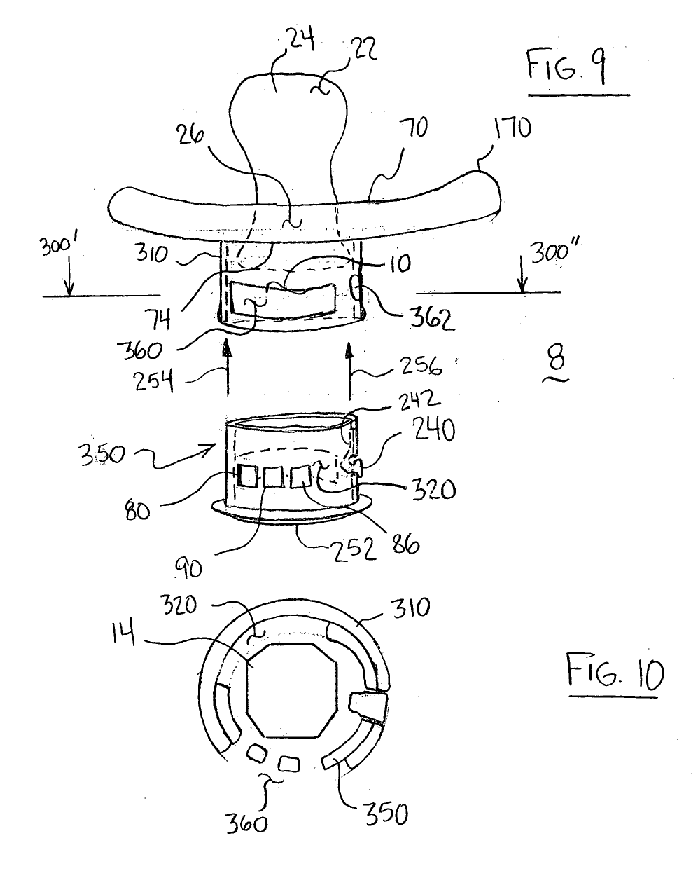

FIGS. 9 and 10 illustrate an alternative embodiment in which the second substantially cylindrical member 350 is rotatably coupled to the first substantially cylindrical member 310 such that the rotating second member 350 is the inner member. In this embodiment, the substantially cylindrical compartment 10 attached to the proximal end 74 of the base member 70 includes a first substantially cylindrical member 310 attached to the base member 70. The first member 310 defines a first opening 360 adapted and sized to allow a medicinal disc 14 (hexagon shaped in FIG. 10) to pass through into the compartment 10. The first member 310 also defines a second opening 362 used in conjunction with the biased lock pin 240.

The vaporizer pacifier 8 of FIGS. 9 and 10 includes a second substantially cylindrical member 350 having a closed end 252 and sized to fit within the first substantially cylindrical member 310 (see arrows 254, 256 in FIG. 9). The second member 350 is rotatably coupled to the first member 310 and defines an opening 320 sized similar to the first opening 360 of the first cylindrical member 310 and also defines a biased lock pin 240.

The biased lock pin 240 of FIGS. 9 and 10 includes a mounting member 242 that attaches to the interior cylindrical wall of second member 350. The mounting member 242 may be made of a memory metal that reverts to its original position after the user depresses the lock pin 240.

The pacifier 8 of this alternative embodiment of FIGS. 9 and 10 works similar to the embodiment illustrated in FIGS. 6 through 8. Functionally, the user can depress lock pin 240 to free rotation of inner second member 350 relative to outer first member 310. In one position, the opening 320 of the second member 350 may be aligned with opening 360 the first member 310 to allow access to the interior of compartment 10. In this first position, the user can change disk 14. In one embodiment, disk 14 is for single use. After a predetermined period of time has elapsed, the user simply discards the old disk 14 and replaces it with a new disk 14. The use of disposable disks 14 enhances the present invention as it avoids possible spillage or adding too much liquid (as is the problem with the prior art devices). Once loaded, the user can rotate the inner member 350 until the lock pin 240 snaps through opening 362, thus locking the members 310, 350. In this second position, aperture holes 80, 90, 86 are exposed through window 360. In another embodiment not illustrated in the figures, but readily understood by one of ordinary skill, the openings 360, 320 and the lock pin 240 and opening 362 can be positioned along the co-centric members 310, 350 such that in the locked position only a portion of opening 320 is left exposed through opening 360, thus providing an aperture through which the vapors emanating from disk 14 can escape compartment 10. In this alternative embodiment, there is no need for apertures 80, 90 and 86.

The claims appended hereto are meant to cover modifications and changes within scope and spirit of the present invention.

What is claimed is:

1. A vaporizer pacifier for an infant comprising:
a base member having an outwardly projecting stop member, said stop member adapted to prevent the pacifier from becoming a choking hazard to said infant;
a nipple having a proximal end coupled to a distal side of said base member and a distal end protruding substantially perpendicular to said outwardly projecting stop member;
a substantially cylindrical compartment attached to a proximal end of said base member, said compartment comprising
a first substantially cylindrical member attached to said base member, said first member defining an opening adapted and sized to allow a medicinal disc to pass through into said compartment, said first member defining at least one aperture having dimensions smaller than the medicinal disc, and said first member defining a biased lock pin; and
a second substantially cylindrical member having a closed end and sized to fit about said first substantially cylindrical member, said second member rotatably coupled to said first member and defining a first opening sized similar to said opening of said first cylindrical member and positioned such that rotation of said second member about said first member causes said first opening to substantially align with said opening of said first member in one position and causes said at least one aperture to be exposed through said first opening of said second member in a second position; said second member defining a second opening shaped to allow at least a portion of said lock pin to protrude through said second member in said second position.

2. A vaporizer pacifier as claimed in claim 1 wherein said at least one aperture is positioned on a portion of said first substantially cylindrical member in close proximity to a portion of said base member adapted to be near the infant's nasal passages.

3. A vaporizer pacifier as claimed in claim 1 further comprising a medicinal disk sized to fit within said compartment and impregnated with an agent that produces vapors.

4. A vaporizer pacifier for an infant comprising:
a base member having an outwardly projecting stop member, said stop member adapted to prevent the pacifier from becoming a choking hazard to said infant;
a nipple having a proximal end coupled to a distal side of said base member and a distal end protruding substantially perpendicular to said outwardly projecting stop member;
a substantially cylindrical compartment attached to a proximal end of said base member, said compartment comprising
a first substantially cylindrical member attached to said base member, said first member defining a first opening adapted and sized to allow a medicinal disc to pass through into said compartment, said first member defining a second opening; and
a second substantially cylindrical member having a closed end and sized to fit within said first substantially cylindrical member, said second member rotatably coupled to said first member and defining an opening sized similar to said first opening of said first cylindrical member and defining a biased lock pin, said opening of said second member positioned such that rotation of said second member within said first member causes said opening of said second member to substantially align with said first opening of said first member in one position, and only a portion of said opening of said second member is exposed through said first opening of said first member and a portion of said lock pin protrudes into said second opening of said first member in a second position.

5. A vaporizer pacifier as claimed in claim 4 wherein said first opening is positioned on a portion of said first substantially cylindrical member in close proximity to a portion of said base member adapted to be near the infant's nasal passages.

6. A vaporizer pacifier as claimed in claim 4 further comprising a medicinal disk sized to fit within said compartment and impregnated with an agent that produces vapors.

7. A vaporizer pacifier for an infant comprising:
a base member having an outwardly projecting stop member said stop member adapted to prevent the pacifier from becoming a choking hazard to said infant;
a nipple having a proximal end coupled to a distal side of said base member and a distal end protruding substantially perpendicular to said outwardly projecting stop member;
a substantially cylindrical compartment attached to a proximal end of said base member, said compartment comprising
a first substantially cylindrical member attached to said base member, said first member defining an opening sized to allow a medicinal disc to pass through into said compartment, said first member defining at least one aperture having dimensions smaller than said medicinal disc, and said first member defining a biased lock pin; and
a second substantially cylindrical member having a closed end and sized to fit about said first substantially cylindrical member, said second member rotatably coupled to said first member and defining a first opening sized similar to said opening of said first cylindrical member and positioned such that rotation of said second member about said first member causes said first opening to substantially align with said opening of said first member in one position and causes said at least one aperture to be exposed through said first opening of said second member in a second position; said second member defining a second opening sized to allow at least a portion of said lock pin to protrude through said second opening in said second position; and
a medicinal disk sized to be inserted into said compartment through said opening of said first member and said first opening of said second member.

8. A vaporizer pacifier as claimed in claim 7 wherein said at least one aperture is positioned on a portion of said first substantially cylindrical member in close proximity to a portion of said base member adapted to be near the infant's nasal passages.

9. A vaporizer pacifier as claimed in claim 7 wherein said medicinal disk is impregnated with an agent that produces vapors adapted to escape said compartment through said at least one aperture.
